(19) United States
(12) Patent Application Publication
(10) Pub. No.: US 2017/0106770 A1
(43) Pub. Date: Apr. 20, 2017

(54) CONNECTING ARRANGEMENT FOR A LINKAGE OF A VEHICLE SEAT, AND VEHICLE SEAT

(71) Applicant: JOHNSON CONTROLS COMPONENTS GMBH & CO. KG, Kaiserslautern (DE)

(72) Inventors: Christian WOLF, Katzenbach (DE); Wolfgang PLUTA, Heiligenmoschel (DE); Heinrich HAMMAN, Teschenmoschel (DE); Viktor ENNS, Kaiserslautern (DE); Thomas DILL, Heiligenmoschel (DE)

(21) Appl. No.: 15/127,089

(22) PCT Filed: Mar. 17, 2015
(86) PCT No.: PCT/EP2015/055498

§ 371 Date: Sep. 19, 2016

(30) Foreign Application Priority Data
Mar. 20, 2014 (DE) 10 2014 205 174.6
Apr. 28, 2014 (DE) 10 2014 207 975.6

(51) Int. Cl. B60N 2/02

(52) U.S. Cl. CPC B60N 2/02

(57) ABSTRACT

A connecting arrangement (1), for a linkage of a vehicle seat, includes a coupling rod (10) and a securing element (40) for securing the coupling rod (10) to a further component (20) of the vehicle seat. The linkage is a part of a lever mechanism for operating a component of the vehicle seat. The further component (20) is a pivotable lever. The coupling rod (10) is introduced into a bearing bush (30) which is connectable to the further component (20) and has a cavity (31), into which the securing element (40) is introduced. A vehicle seat is provided which has at least one such connecting arrangement.

### CROSS REFERENCE TO RELATED APPLICATIONS

This application is a United States National Phase Application of International Application PCT/EP2015/055498 filed Mar. 17, 2015, and claims the benefit of priority under 35 U.S.C. §119 of German Patent Applications 10 2014 205 174.6 filed Mar. 20, 2014, and 10 2014 207 975.6 filed Apr. 28, 2014, the entire contents of which are incorporated herein by reference.

### FIELD OF THE INVENTION

The invention concerns a connecting arrangement for a linkage of a vehicle seat with a coupling rod and a securing element for securing the coupling rod to a further component of the vehicle seat, wherein the linkage is part of a lever mechanism for operating a component of the vehicle seat, and the further component is a pivotable lever. The invention also concerns s a vehicle seat with such a connecting arrangement for a linkage.

### BACKGROUND OF THE INVENTION

A connecting arrangement of this kind for a linkage comprises a coupling rod, which is to be fastened to another component. The coupling rod must be fastened to the other component in a precisely defined position. A securing element is provided for the securing and fixation of the coupling rod. Part-related tolerances, especially the length of the coupling rod, should be equalized during the fastening process.

Coupling rods are known through use, which have grooves set off from each other along their longitudinal axis. During the fastening of the coupling rod, a securing disk open at one side is inserted into one of the grooves as a securing element. An equalizing of tolerances is then possible within a grid pattern dictated by the spacing of the grooves from each other.

Moreover, it is known practice to shove a securing disk, a central opening, as the securing element onto the coupling rod in the direction of its longitudinal axis. The shoving on of such a securing disk is, however, only possible if one end of the coupling rod is freely accessible. Moreover, such a connecting arrangement can only absorb forces in one direction.

It is also known practice to provide the coupling rod with a thread, on which a securing nut as the securing element is screwed. The screwing on of such a securing nut is likewise only possible if one end of the coupling rod is freely accessible. The adjustment process here is also relatively cumbersome.

Coupling rods are also known which consist of two parts, each of them provided with an external thread. One part has an external thread designed as a right-hand thread and the other part has an external thread designed as a left-hand thread. By turning a turnbuckle, which constitutes the securing element and which has an internal thread designed as a right-hand thread and an internal thread designed as a left-hand thread and displaced in the direction of its longitudinal axis, the distance of the two parts relative to each other can be adjusted. The adjustment process is likewise relatively cumbersome.

### SUMMARY OF THE INVENTION

The problem which the invention proposes to solve is to improve a connecting arrangement for a linkage of a vehicle seat of the kind mentioned above, in particular to simplify the adjustment process, and to provide a corresponding vehicle seat.

A connecting arrangement of this kind for a linkage of a vehicle seat comprises a coupling rod and a securing element for securing the coupling rod to a further component of the vehicle seat. By securing is meant in particular a fastening in the direction of extension of the coupling rod to the a further component.

As claimed in the invention, the coupling rod is introduced into a bearing bush which can be connected to the further component, which has a cavity into which the securing element is introduced.

Thanks to the design as claimed in the invention, the mounting of the connecting arrangement is advantageously simplified. Neither does any end of the coupling rod need to be freely accessible. The mounting is relatively fast, simple, and flawless. In particular, no active adjustment is required, especially when the position of the further component is defined by an end stop. Furthermore, no special tool is needed for the mounting.

Tolerances, especially a manufacturing tolerance for the length of the coupling rod, can be equalized relatively precisely.

The number of required parts for the connecting arrangement is relatively small.

According to one advantageous modification of the invention, the bearing bush has a pot-shaped region. Thanks to this, the bearing bush can be introduced into a circular round through opening of the further component, especially a lever or a metal plate, and turned relative to the lever or the metal plate. A nondestructive dismounting of the connecting arrangement is also possible.

The pot-shaped region in particular has an approximately rotationally symmetrical contour.

Advantageously, the pot-shaped region largely encloses the cavity into which the securing element is introduced.

Advantageously, the bearing bush has a receiving opening, which extends from an envelope surface of the pot-shaped region as far as the cavity, and into which the coupling rod is introduced.

As claimed in one advantageous embodiment of the invention, an end face of the pot-shaped region has an insert opening, into which the securing element is introduced. In this way, the securing element can be introduced relatively easily into the bearing bush.

As claimed in one advantageous modification of the invention, one end face of the pot-shaped region is surrounded by a flange which projects outwardly in the radial direction. When the bearing bush is introduced into a through opening of the further component, especially a lever or a metal plate, the flange prevents a displacement of the bearing bush in the axial direction.

Preferably, at least one projection extending outwardly in the radial direction is disposed on an envelope surface of the pot-shaped region, which projection likewise prevents a displacement of the bearing bush relative to the further component, especially the lever or the metal plate, in the axially opposite direction.

Advantageously, the flange and the projection enclose the further component, especially the metal plate or the lever, between them. Thus, the bearing bush is secured in the axial direction on the further component.

As claimed in one preferred embodiment of the invention, an external thread is provided at one end region of the coupling rod, which projects at least partly into the cavity. The external thread makes possible a form-fitting connection of the coupling rod with the securing element. Moreover, an additional fine tuning of the connecting arrangement and the linkage made possible by a rotation of the coupling rod.

Instead of an external thread with a pitch, the coupling rod can also have a knurling, a toothing, or grooves.

For this, the securing element preferably has at least two teeth, which engage with the external thread of the coupling rod, especially by form fitting. After the mounting, the teeth cooperate with the external thread of the coupling rod in the manner of a screw connection.

Especially advantageously, the securing element has three teeth, which engage with the external thread of the coupling rod, especially by form fitting.

Advantageously, the bearing bush consists of plastic. This prevents unwanted noises as well as material strain during a movement of the bearing bush relative to the lever.

The problem is also solved by a vehicle seat with the features of claim 15, having at least one connecting arrangement as claimed in the invention.

In the following, the invention is explained more closely with the aid of an advantageous sample embodiment represented in the figures. However, the invention is not limited to this sample embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded view of a connecting arrangement for a linkage;

FIG. 2 is a perspective representation of the connecting arrangement of FIG. 1 in the mounted state;

FIG. 3 is another perspective representation of the connecting arrangement of FIG. 1 in the mounted state; and

FIG. 4 is another perspective representation of the connecting arrangement of FIG. 1 in the mounted state.

### DESCRIPTION OF THE PREFERRED EMBODIMENTS

Referring to the drawings, a connecting arrangement 1 for a linkage of a vehicle seat comprises a coupling rod 10, a bearing bush 30, and a securing element 40, which in the present case is configured as a clamp. The connecting arrangement 1 serves to connect the coupling rod 10 to a further component, especially a pivotable lever.

The linkage can be, as in the present case, part of a lever mechanism for operating one component of the vehicle seat. But the linkage can also be part of a truss-like static structure of the vehicle seat, for example.

The coupling rod 10 is in the shape of a shaft and has an approximately circular cylindrical cross section. At a first end region of the coupling rod 10 there is arranged an external thread 12. The coupling rod 10 is connected at its first end region to a further component of the vehicle seat, which in the present case is a pivotable lever 20. A second end region of the coupling rod 10, opposite the first end region, is in the present case connected to a fitting of the vehicle seat (not shown). The coupling rod 10 in the present case consists of metal.

By swiveling the lever 20 about a swivel axis, the coupling rod 10 is moved and thereby opens the fitting. The coupling rod 10 acts as a pull rod in this process and undergoes a translatory motion along its longitudinal axis, as well as a slight rotational movement about an axis of rotation A relative to the lever 20.

The lever 20 in the present case is designed as a flat plate part and consists of metal. The lever 20 has a through opening 25, having a central hole and two margin zones. The central hole is designed as a round circular opening. The margin zones extend from a circumferential line of the round circular opening to the outside and are situated diametrically opposite each other.

The bearing bush 30 has an approximately rotationally symmetrical contour. In the present case, the bearing bush 30 consists of plastic. The center axis of the bearing bush 30 defines a cylindrical system of coordinates, to which reference shall be made hereafter. In the present case, the center axis of the bearing bush 30 coincides with the axis of rotation A.

The bearing bush 30 comprises a pot-shaped region 32, which is approximately hollow cylindrical and rotationally symmetrical in configuration and has an envelope surface. The outer diameter of the pot-shaped region 32 of the bearing bush 30 corresponds to around the diameter of the central hole of the through opening 25 of the lever 20. A first end face of the pot-shaped region 32 is closed here. A second end face, opposite the first end face, has an insert opening 35. The pot-shaped region 32 encloses a cavity 31 of the bearing bush 30.

The insert opening in one modification of the sample embodiment can also be arranged on the envelope surface of the pot-shaped region 32.

The second end face of the pot-shaped region 32, having the insert opening 35, is surrounded by a flange 34. The flange 34 has a larger extension in the radial direction than the pot-shaped region 32.

Projections 36 are provided, standing off in the radial direction from the envelope surface of the pot-shaped region 32. In the present case, the pot-shaped region 32 has two such projections 36, which are disposed diametrically opposite each other on the envelope surface of the pot-shaped region 32 and which extend in the radial direction to approximately the same the extent as the flange 34.

The pot-shaped region 32 moreover has a receiving opening 37. The receiving opening 37 runs from the envelope surface of the pot-shaped region 32 in the radial direction as far as the cavity 31 of the bearing bush 30. In the present case, the receiving opening 37 is designed as a round circular bore, the diameter of the receiving opening 37 corresponding approximately to the outer diameter of the coupling rod 10.

The securing element 40 in the present case is designed as a flat plate part and consists of metal. The securing element 40 is approximately mirror symmetrical in configuration and has a width which corresponds approximately to the width of the insert opening 35 of the bearing bush 30. By the width of the securing element 40 is meant in this context its extension perpendicular to its plane of symmetry.

The securing element 40 has a support opening 45, which is designed approximately as a round circular hole. The diameter of the support opening 45 corresponds approximately to the outer diameter of the coupling rod 10, or the core diameter of the external thread 12, as well as the diameter of the receiving opening 37 of the bearing bush 30.

The securing element 40 has an aperture 47, which extends from a margin region of the securing element 40 as far as the support opening 45. The aperture 47 is approximately funnel shaped, one narrow side passing into the support opening 45 and one broad side opening a margin region of the securing element 40. The securing element 40 thus has two teeth 42, which receive the support opening 45 and the aperture 47 between them.

In the present case, the securing element 40 also has a third tooth, not visible in the figures. The third tooth is disposed on an edge of the support opening 45 opposite the aperture 47 and protrudes into the support opening 45.

During the mounting of the linkage, at first the bearing bush 30 is connected to the lever 20. For this, the pot-shaped region 32 of the bearing bush 30 is inserted in the axial direction into the through opening 25 of the lever 20. The projections 36 of the bearing bush 30 are flush with the margin zones of the through opening 25 of the lever 20. When the flange 34 of the bearing bush 30 lies against the lever 20, the bearing bush 30 is turned relative to the lever 20 about the axis of rotation A until the projections 36 of the bearing bush 30 are moved away from the margin zones of the through opening 25 and also lie against the lever 20. The flange 34 and the projections 36 now enclose the lever 20 in the axial direction. Thus, the bearing bush 30 is joined by form fit to the lever 20 in the axial direction.

Next, the external thread 12 of the coupling rod 10 is inserted into the receiving opening 37 of the bearing bush 30. The external thread 12 of the coupling rod 10 thus protrudes at least partly into the cavity 31 of the bearing bush 30.

For the adjusting of the linkage, in the present case the lever mechanism, the lever 20 is then swiveled about its swivel axis until it has taken up its nominal position. In the swiveling of the lever 20 about its swivel axis, the bearing bush 30 moves relative to the coupling rod 10. This changes the depth of penetration of the external thread 12 of the coupling rod 10 into the cavity 31 of the bearing bush 30.

Thanks to the adjustment process, i.e., the swiveling of the lever 20 into its nominal position, tolerances are equalized, especially a manufacturing tolerance for the length of the coupling rod 10.

After the adjustment of the linkage has been carried out, in the present case the lever mechanism, the coupling rod 10 is fixed by means of the securing element 40 on the bearing bush 30. For this, the securing element 40 is shoved, with the teeth 42 in front, in the axial direction into the insert opening 35 of the bearing bush 30 so that the teeth 42 as well as the third tooth engage by form fit with the external thread 12 of the coupling rod 10.

The external thread 12 of the coupling rod 10 thus protrudes through the support opening 45 of the securing element 40. The teeth 42 as well as the third tooth at the edge of the support opening 45 of the securing element 40 grasp one turn of the external thread 12 of the coupling rod 10 by form fit and force fit. Thus, the coupling rod 10 is secured in the bearing bush 30 in the radial direction, which corresponds to the direction of the longitudinal axis of the coupling rod 10.

The teeth 42 as well as the third tooth undergo a bending in this process in the direction of the longitudinal axis of the coupling rod 10. This produces a further strengthening of the connecting arrangement 1 in the direction of the longitudinal axis of the coupling rod 10.

If need be or optionally, an additional fine tuning of the linkage can be carried out by a rotation of the coupling rod 10 about its longitudinal axis.

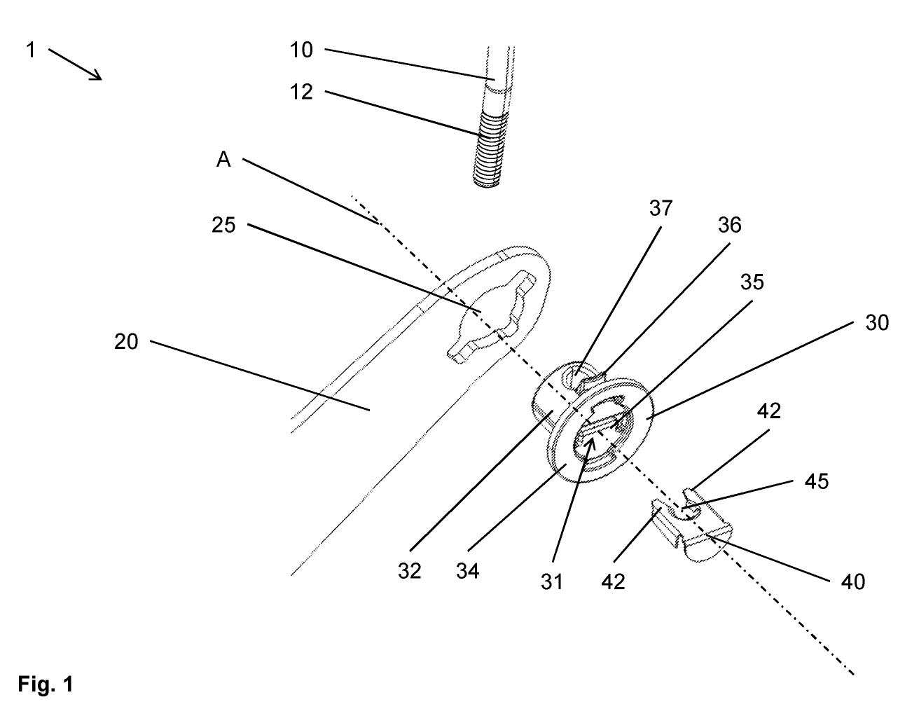

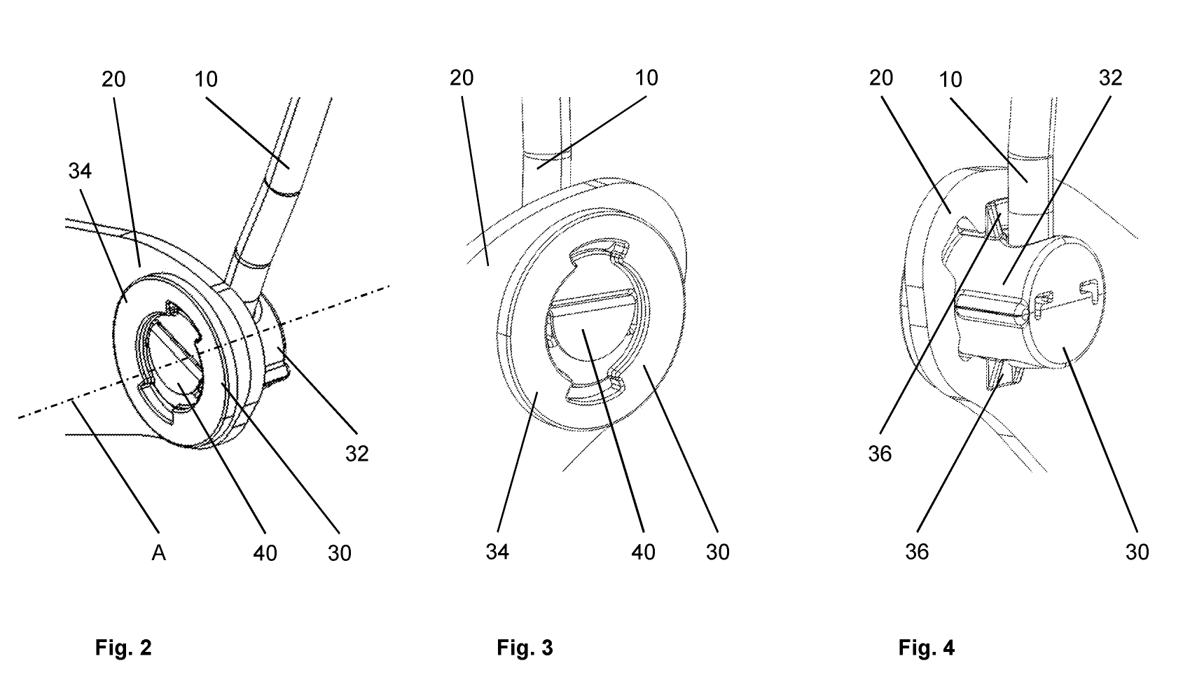

When the securing element 40 is shoved into the insert opening 35 of the bearing bush 30, the teeth 42 of the securing element 40 undergo a plastic deformation upon striking against the coupling rod 10. Upon further shoving in of the securing element 40, when the external thread 12 of the coupling rod 10 lies against the support opening 45 of the securing element 40, the elastic deformation of the teeth 42 of the securing element 40 relaxes. The teeth 42 of the securing element 40 again take up their original form, as shown in FIG. 1, and engage with form fit in the external thread 12 of the coupling rod 10. The securing element 40 is thereby secured in the bearing bush 30 in the axial direction.

It is also conceivable for the securing element 40, upon being shoved into the bearing bush 30, to press a material part of the bearing bush 30 outwardly in the radial direction, so that said material part of the bearing bush 30 lies against the lever 20 and secures the bearing bush 30 in the axial direction.

The bearing bush 30 in the present sample embodiment is mounted on the lever 20 and able to turn about the axis of rotation A. The coupling rod 10 is connected to the lever 20 by means of the bearing bush 30 and the securing element 40.

The features disclosed in the above specification, the claims and the drawings, can be of significance both individually and in combination for the realization of the invention in its various embodiments.

While specific embodiments of the invention have been shown and described in detail to illustrate the application of the principles of the invention, it will be understood that the invention may be embodied otherwise without departing from such principles.

1. A connecting arrangement for a linkage of a vehicle seat, the connecting arrangement comprising:
a coupling rod;
a bearing bush; and
a securing element for securing the coupling rod to a further component of the vehicle seat, wherein the linkage is part of a lever mechanism for operating a component of the vehicle seat, and the further component is a pivotable lever, wherein the coupling rod is introduced into the bearing bush which can be connected to the further component, which bearing bush has a cavity into which the securing element is introduced.

2. The connecting arrangement as claimed in claim 1, wherein the bearing bush has a pot-shaped region.

3. The connecting arrangement as claimed in claim 2, wherein the pot-shaped region has an approximately rotationally symmetrical contour.

4. The connecting arrangement as claimed in claim 2, wherein the pot-shaped region largely encloses the cavity.

5. The connecting arrangement as claimed in claim 4, wherein the bearing bush has a receiving opening, which extends from an envelope surface of the pot-shaped region as far as the cavity, and into which the coupling rod is introduced.

6. The connecting arrangement as claimed in claim 4, wherein an end face of the pot-shaped region has an insert opening, into which the securing element is introduced.

7. The connecting arrangement as claimed in claim 6, wherein one end face of the pot-shaped region is surrounded by a flange which projects outwardly in the radial direction.

8. The connecting arrangement as claimed in claim 2, wherein at least one projection, extending outwardly in the radial direction, is disposed on an envelope surface of the pot-shaped region.

9. The connecting arrangement as claimed in claim 1, wherein an external thread is provided at one end region of the coupling rod, which projects at least partly into the cavity.

10. The connecting arrangement as claimed in claim 9, wherein the securing element has at least two teeth, which engage with the external thread.

11. The connecting arrangement as claimed in claim 10, wherein precisely three teeth are provided.

12. The connecting arrangement as claimed in claim 10, wherein the teeth engage with the external thread by form fitting.

13. The connecting arrangement as claimed in claim 1, wherein the coupling rod has a knurling or a toothing or grooves at an end region.

14. The connecting arrangement as claimed in claim 13, wherein the bearing bush consists of plastic.

15. A vehicle seat comprising:
pivotable lever for actuating a lever mechanism for operating a component of the vehicle seat; and
at least one connecting arrangement comprising:
a coupling rod;
a bearing bush; and
a securing element for securing the coupling rod to the lever, wherein the coupling rod is introduced into the bearing bush which is connected to the lever which bearing bush has a cavity into which the securing element is introduced.

16. A vehicle seat as claimed in claim 15, wherein the bearing bush has a pot-shaped region largely enclosing the cavity.

17. A vehicle seat as claimed in claim 16, wherein the bearing bush has a receiving opening, which extends from an envelope surface of the pot-shaped region as far as the cavity, and into which the coupling rod is introduced.

18. A vehicle seat as claimed in claim 17, wherein an end face of the pot-shaped region has an insert opening, into which the securing element is introduced.

19. A vehicle seat as claimed in claim 18, wherein:
one end face of the pot-shaped region is surrounded by a flange which projects outwardly in the radial direction; and
at least one projection, extending outwardly in the radial direction, is disposed on an envelope surface of the pot-shaped region.

20. A vehicle seat as claimed in claim 18, wherein:
an external thread is provided at one end region of the coupling rod, which projects at least partly into the cavity;
the securing element has teeth, which engage with the external thread and the teeth engage with the external thread.
